(19) United States
(12) Patent Application Publication
(10) Pub. No.: US 2017/0044073 A1
(43) Pub. Date: Feb. 16, 2017

(54) NON-EXPLOSIVE AND NON-FLAMMABLE NITROGENOUS FERTILIZER BASED ON AMMONIUM NITRATE

(71) Applicants: Mohamed OUADDAY, Tunis (TN); Hamza DAHMANI, Tunis (TN); Mohamed MAKNI, Tunis (TN)

(72) Inventors: Mohamed OUADDAY, Tunis (TN); Hamza DAHMANI, Tunis (TN); Mohamed MAKNI, Tunis (TN)

(21) Appl. No.: 15/304,342

(22) PCT Filed: May 6, 2014
(86) PCT No.: PCT/TN2014/000003

§ 371 Date: Oct. 14, 2016

(30) Foreign Application Priority Data
Apr. 15, 2014 (TN) TN2014/0159

(51) Int. Cl. C05C 1/02; C05G 3/00

(52) U.S. Cl. CPC C05C 1/02; C05G 3/0082; C05G 3/0094

(57) ABSTRACT

The present invention, entitled “Non-explosive and non-flammable nitrogenous fertilizer based on ammonium nitrate”, is a chemical fertilizer intended, mainly, for the contribution in nitrogen input into agricultural soils, essentially in granule form. Said product solves or minimizes many of the main problems found in the chemical fertilizer industry, including the following: the use of fertilizers in the production of explosives for terrorism purposes; the release of noxious gases and greenhouse gases, such as NOx and ammonia; the contamination of water tables by the run-off of chemical substances, especially nitrates, owing to rainfall; and chemical fertilizers having fixed content in terms of nitrogen percentage. The present invention, “Non-explosive nitrogenous fertilizer based on ammonium nitrate”, can contain a variable nitrogen concentration of 30% to 40%.

### INTRODUCTION AND TECHNICAL FIELD OF THE INVENTION

As indicated by the name of the invention, “Non-explosive and non-flammable nitrogenous fertilizer based on ammonium nitrate”, it is a chemical fertilizer intended mainly for nitrogen input for soil enrichment in the agricultural sector while at the same time having the ability to be sold in solid, granule form.

### PRIOR ART AND PROBLEMS

The nitrogenous chemical fertilizer industry, mainly ammonium nitrate and urea, encounters several problems which can cause others in various sectors (safety, water resources, environment, etc.), of which the following may be mentioned:
Use of fertilizers in the production of explosives for terrorism purposes.
Release of noxious gases and greenhouse gases, such as NOₓ and ammonia.
Contamination of groundwater by run-off of chemical substances, especially nitrates, owing to rainfall which infiltrate into the soil.
Most processes for manufacturing nitrogenous chemical fertilizers give fixed and invariant contents in terms of nitrogen percentage in the marketed product.
Difference, in practice, between the real nitrogen provision yield and the optimal yield which varies between the various types of fertilizer.
Technical difficulties encountered in the industrial manufacture of mixtures of urea and ammonium nitrate for the purpose of producing fertilizer in the solid state.

### SOLUTIONS AND ADVANTAGES EFFECTS PROVIDED

The objective of the invention of this fertilizer is to achieve a definitive solution to the problem of safety resulting from the risks of explosion and of self-incineration of nitrogenous chemical fertilizers and also the uses thereof for the production of explosives by terrorists. Several solutions have also been explored for the risks of contamination of groundwater and the release of gas pollutants, while at the same time attempting and trying to restrict them and to contain and limit their effects. In addition, this product seeks to allow chemical fertilizer industries to have much greater flexibility with respect to nitrogen contents in the products currently sold on the market, while at the same time contributing to facilitating the granulation phase, which can prove to be extremely useful for the industry from the point of view of marketing and satisfaction of the various customer needs, this being while saving energy and profit.

### DISCLOSURE OF THE PRODUCT AND THE PROCESS FOR THE MANUFACTURE THEREOF

The present invention derives from a manufacturing process specially designed for this product which amounts to the polymerization (complexation) of urea with formaldehyde in an ammonium nitrate solution catalyzed by an acid, the manufacture of which is carried out as follows:
1. Mixing urea, ammonium nitrate and formaldehyde in water.
2. Stirring until homogenization of the mixture.
3. Adding the catalyst.
4. Stirring if necessary.
5. Waiting with or without maintaining the stirring until the end of the reaction.
6. Drying, which may or may not be followed by granulation of the product obtained.

The mixing of the urea, ammonium nitrate and formaldehyde in water can be carried out according to several methods, among which mention may be made of the following:
Adding ammonium nitrate and urea to formol.
Adding urea and formaldehyde to an aqueous solution of ammonium nitrate.
Adding the ammonium nitrate and the formaldehyde to an aqueous solution of urea.

The main thing is to have an aqueous mixture of these three substances without the urea and formaldehyde remaining mixed, by themselves, for a period of time sufficient to initiate any polymerization reaction.

The initial mixing of the urea, the ammonium nitrate and the formol or formaldehyde can be carried out using these substances in pure form or of industrial quality: ammonium nitrate (33% N); urea (46% N) and formol (37.5%) or other concentration.

The final product can contain between 30 and 40% of nitrogen after drying since the initial mixture can accommodate moderate variations in the weight percentages relating to its compounds.

The proportion of formaldehyde relative to urea allows only a very slight modification, whereas the proportion of ammonium nitrate can tolerate greater variations.

The proportion of ammonium nitrate must not be excessively predominant, in order to maintain the non-flammability of the final product and the fact that it is of no use for the manufacture of explosives for terrorism purposes.

Indeed, in order to obtain a fertilizer with a nitrogen percentage between 32 and 36%, the initial mixture must adhere to the following proportions:
commercial ammonium nitrate (33% N) in a weight proportion of 51.5% of the mixture;
urea (46% N) in a weight proportion of 20% of the mixture;
formol of concentration 37.5% in a percentage of 28.5% of the weight of the initial mixture.

The reaction is essentially catalyzed by acids.

The acid catalyzing the reaction may be weak, strong or a mixture; however, a weak and/or dilute acid gives a tab which is more malleable and which is capable of facilitating the granulation of the product, whereas a strong and/or concentrated acid limits the reaction time.

It is strongly recommended not to use acids which give salts that can degrade the quality of the fertilizer.

The mixture, after the addition of the catalyst, may or may not require moderate stirring according to the industrial manufacturing techniques used; if the mixture undergoes a flow immediately after the addition of the catalyst, then metered pumping thereof is sufficient.

The wait for the end of the reaction varies enormously with the amount, the nature and the concentration of the catalyst used.

The drying is optimal at around 50° C. or even less; however, it may be carried out at higher temperatures in so far as the acceleration of the procedure allows, while at the same time taking into account the generation of a small release of nitrogen-containing gases.

In order to obtain a tab which is malleable and in perfect condition for granulation, moderate drying is sufficient.

Said invention is characterized by the non-flammability and its sterile nature and inactive nature with respect to its use as an explosive or an ingredient for manufacturing explosives; this fertilizer cannot be used for terrorism purposes or cause accidental explosions following its self-incineration, such as ammonium nitrate.

This product takes longer to release all of the nitrogen that it contains into the receiving soil since immediate and early dissolution affects only a part of the fertilizer, while the remainder is released more slowly and in a delayed manner over a variable period of time depending on the nature and, especially, the acidity or the alkalinity of the soil; thereby resulting in:
Reduced release of noxious gases and greenhouse gases such as NOₓ and ammonia.
Reduced contamination of groundwater by run-off of chemical substances owing to rainfall.
Increased yield of nitrogen assimilation by plants.

The process for manufacturing this fertilizer is characterized by the facilitation of the granulation phase given the pasty form of the product at the end of the chemical reaction previously explained.

### PROCEDURE

In order to achieve the main objective of the invention, which is summarized by the enrichment of soils with nitrogen for the agriculture sector, the procedure, which contributes to a very good quality, envisioned for the manufacture of this product comprises the steps listed as follows:
1. Mixing commercial ammonium nitrate (33% N) with agricultural urea (46% N) and formol (37.5%) in the following proportions by weight:
   commercial ammonium nitrate (33% N): 51.5% of the mixture;
   urea (46% N): 20% of the mixture;
   formol having a concentration of 37.5%: 28.5% of the weight of the mixture.
2. Stirring for a few minutes until total dissolution of the solid additions and homogenization of the mixture.
3. Adding 6° acetic acid in a proportion by weight of 6%.
4. Stirring for 10 minutes.
5. Waiting for a maximum of eight hours for the reaction to take place.
6. Moderate drying at 50° C. until a consistent tab is obtained.
7. Granulating followed by accentuated drying at 50° C.

### SUMMARY

Thus, said invention, entitled “Non-explosive and non-flammable nitrogenous fertilizer based on ammonium nitrate”, amounts to a chemical fertilizer which enriches the soil with nitrogen in varied forms, ammonium ions and nitrates, for a period of time greater than those of the usual fertilizers (ammonium nitrate and urea) without risks of self-incineration and explosion. In addition, this product reduces the risks of contamination of groundwater by run-off of chemical substances owing to rainfall and of release of noxious gases such as ammonia and NOₓ.

1. A nitrogenous chemical fertilizer hereinafter called “Non-explosive and non-flammable nitrogenous fertilizer based on ammonium nitrate”, manufactured essentially from ammonium nitrate, urea and formaldehyde and which can be sold in the non-flammable and non-explosive solid state.

2. A nitrogenous chemical fertilizer hereinafter called “Non-explosive and non-flammable nitrogenous fertilizer based on ammonium nitrate” as claimed in claim 1, of which the synthesis process is carried out as follows:
a) Mixing urea, ammonium nitrate and formaldehyde in water.
b) Stirring until homogenization of the mixture.
c) Adding a catalyst.
d) Stirring if necessary.
e) Waiting with or without maintaining the stirring until the end of the reaction.
f) Drying, which may or may not be followed by granulation of the product obtained.

3. The invention as claimed in claim 1, has as main objective the enrichment of soils with nitrogen in various ionic forms which can be sold in the form of granules.

4. The invention as claimed in claim 1, derives essentially from an aqueous mixture of formaldehyde, ammonium nitrate and urea which can be prepared according to any method, the urea and formaldehyde of which do not remain mixed, by themselves, for a period of time sufficient to initiate any chemical reaction of polymerization or the like.

5. The invention as claimed in claim 1, can be synthesized from urea, ammonium nitrate and formaldehyde in their pure forms or from their forms of industrial and/or commercial quality.

6. The process for synthesis of the “Non-explosive and non-flammable nitrogenous fertilizer based on ammonium nitrate” as claimed in claim 2, is essentially catalyzed by acids which may be weak, strong or mixtures of acids.

7. The synthesis process as claimed in claim 6, if catalyzed by a weak and/or dilute acid gives a tab which is more malleable and which is capable of facilitating the granulation of the product, whereas a strong and/or concentrated acid reduces the reaction time.

8. The mixture, after the addition of the catalyst, as claimed in of claim 2, may or may not require moderate stirring according to the industrial manufacturing techniques used; if the mixture undergoes a flow immediately after the addition of the catalyst, then metered pumping thereof is sufficient.

9. The invention as claimed in claim 2, requiring waiting for the end of the reaction which varies with the amount, the nature and the concentration of the catalyst used.

10. The invention as claimed in f) of claim 2, undergoes drying which is optimal at around 50° C. or even less; however, it may be carried out at higher temperatures in so far as the acceleration of the manufacturing procedure allows.

11. The invention as claimed in claim 10, requires drying which, in the case where the final product is in granule form, is moderate and results in a tab ready to undergo granulation and then final drying.

12. Said invention as claimed in claim 1, is characterized by the non-flammability and its sterile nature and inactive nature with respect to its use as an explosive or an ingredient for manufacturing explosives; these features prevent the use of the invention for terrorism purposes or cause accidental explosions following its self-incineration.

13. The invention as claimed in claim 1 releases all of the nitrogen that it contains into the receiving soil, little by little and slowly since immediate and early dissolution affects only a part of the fertilizer, while the remainder is released more slowly and in a delayed manner over a variable period of time depending on the nature and, especially, the acidity or the alkalinity of the soil; thereby resulting in:
Reduced release of noxious gases and greenhouse gases such as NOₓ and ammonia.
Reduced contamination of groundwater by run-off of chemical substances owing to rainfall.
Increased yield of nitrogen assimilation by plants.

14. The invention as claimed in claim 1, is characterized by the facilitation of the granulation phase at the end of the synthesis process which results in a tab.

15. The “Non-explosive and non-flammable nitrogenous fertilizer based on ammonium nitrate” as claimed in claim 1 can be synthesized so as to contain between 30 and 40% of nitrogen after drying.

16. The invention as claimed in claim 15, is characterized by a nitrogen percentage between 32 and 36% after drying in the case where the proportions by weight in the initial mixture are as follows:
commercial ammonium nitrate (33% N) in a weight proportion of 51.5% of the mixture;
urea (46% N) in a weight percentage of 20% of the mixture;
formol having a concentration of 37% in a percentage of 28.5% of the weight of the initial mixture.

17. The invention as claimed in claim 15, can accommodate a moderate variation in the percentage of ammonium nitrate relative to the other ingredients for the purpose of modifying the nitrogen content of the product.
